(19) United States
(12) Patent Application Publication
(10) Pub. No.: US 2025/0287146 A1
(43) Pub. Date: Sep. 11, 2025

(54) AUDIO ZOOM METHOD, AUDIO ZOOM DEVICE, FOLDABLE SCREEN DEVICE, AND STORAGE MEDIUM

(71) Applicant: HUIZHOU TCL MOBILE COMMUNICATION CO., LTD., Huizhou, Guangdong (CN)

(72) Inventors: Subi SHI, Huizhou, Guangdong (CN); Yaogang CHEN, Huizhou, Guangdong (CN)

(73) Assignee: HUIZHOU TCL MOBILE COMMUNICATION CO., LTD., Huizhou, Guangdong (CN)

(21) Appl. No.: 18/700,631

(22) PCT Filed: Sep. 7, 2022
(86) PCT No.: PCT/CN2022/117617

§ 371 Date: May 21, 2025

(30) Foreign Application Priority Data
Oct. 11, 2021 (CN) 202111183467.0

(51) Int. Cl. H04R 3/00; G02B 7/40; H04M 1/02; H04M 1/60; H04N 23/69; H04R 1/02; H04R 1/40

(52) U.S. Cl. CPC H04R 3/005; G02B 7/40; H04M 1/0243; H04M 1/0268; H04M 1/6008; H04N 23/69; H04R 1/028; H04R 1/406; H04M 1/0214; H04R 2410/01; H04R 2430/01; H04R 2499/11; H04R 2499/15

(57) ABSTRACT

The embodiments of the present application discloses a method and apparatus for audio zoom, and a folding screen device and a storage medium. The method comprises: loading audio zoom parameters preset in a folding screen device; receiving an audio zoom request sent by a user; acquiring a folding angle of the folding screen device; invoking an audio parameter of the audio zoom parameters which is matched to the folding angle, and, in accordance with the audio parameter, performing audio zoom in the folding screen device. The present application can solve the technical problem in the prior art whereby audio zoom performance is poor at a plurality of angles during the folding of a folding-screen mobile phone.

This application claims priority to Chinese Application No. 202111183467.0, entitled “AUDIO ZOOM METHOD, AUDIO ZOOM DEVICE, FOLDABLE SCREEN DEVICE, AND STORAGE MEDIUM,” filed on Oct. 11, 2021. The entire disclosures of the above applications are incorporated herein by reference.

### FIELD OF THE INVENTION

The present disclosure relates to the field of communication technology, more particularly, to an audio zoom method, an audio zoom device, a foldable screen device, and a storage medium.

### BACKGROUND

Currently, during a video shooting, smartphones can focus an image to a preset position through audio zoom technology, so as to record a required sound source, and then shoot a required video for a user.

As audio zoom technology has been widely used in smartphones, audio zoom technology is also used in smartphones with foldable screens. Because sound pickup microphones are disposed in fixed positions in a mobile phone with a foldable screen, when the mobile phone with the foldable screen is folded at multiple angles, a relative positional relationship of the sound pickup microphones changes, which affects an audio zoom effect when shooting video.

### SUMMARY

### Technical Problem

The present disclosure provides an audio zoom method, an audio zoom device, a foldable screen device, and a storage medium to solve a technical problem in the existing technology that an audio zoom effect is poor when folding a screen of a foldable screen device at multiple angles for video shooting.

### SOLUTION TO TECHNICAL PROBLEM

### Technical Solution

In order to solve the above-mentioned technical problems, the technical scheme adopted in the present disclosure is as follows:

In a first aspect, the present disclosure provides an audio zoom method, which comprises:

loading an audio zoom parameter preset in the foldable screen device;

receiving an audio zoom request sent by a user;

obtaining a folding angle of the foldable screen device; and

calling an audio parameter that matches the folding angle from the audio zoom parameter, and performing audio zoom in the foldable screen device according to the audio parameter.

In a second aspect, the present disclosure provides an audio zoom device, which comprises:

a loading unit configured to load an audio zoom parameter preset in the foldable screen device;

a receiving unit configured to receive an audio zoom request sent by a user;

a first obtaining unit configured to obtain a folding angle of the foldable screen device; and

a first calling unit configured to call an audio parameter that matches the folding angle from the audio zoom parameter, and perform audio zoom in the foldable screen device according to the audio parameter.

In a third aspect, the present disclosure provides a foldable screen device, which comprises a memory, a processor, and a computer program stored in the memory and executable by the processor. The processor executes the computer program to perform the audio zoom method as described in the first aspect.

In a fourth aspect, the present disclosure provides a computer readable storage medium storing computer instructions that cause the processor to perform the audio zoom described in the first aspect when the processor is executed.

### BENEFICIAL EFFECT OF THE PRESENT DISCLOSURE

### Advantageous Effect

In contrast to the prior art, the present disclosure provides an audio zoom method, an audio zoom device, a foldable screen device, and a storage medium. The audio zoom method includes: loading an audio zoom parameter preset in the foldable screen device; receiving an audio zoom request sent by a user; obtaining a folding angle of the foldable screen device; and calling an audio parameter that matches the folding angle from the audio zoom parameter, and performing audio zoom in the foldable screen device according to the audio parameter. In the present disclosure, parameters for audio zoom are pre-loaded in the foldable screen device. When a user requests the audio zoom, the foldable screen device directly obtains a folding angle of the foldable screen device, and then obtains one parameter that matches the folding angle from the loaded parameters based on the folding angle, thereby realizing automatic audio zoom on a foldable screen. This solves solve the technical problem in the existing technology that an audio zoom effect is poor when a foldable screen phone is folded at multiple angles.

### BRIEF DESCRIPTION OF DRAWINGS

### Description of the Drawings

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be obtained according to these drawings without creative labor.

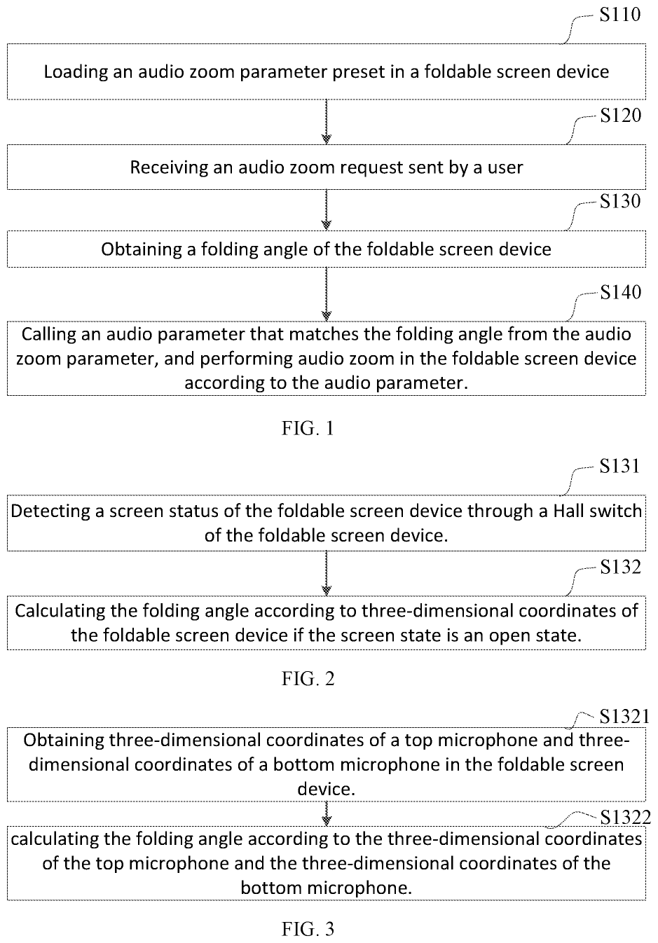

FIG. 1 is a schematic flowchart of an audio zoom method according to an embodiment of the present disclosure.

FIG. 2 is a schematic flowchart of step S130 of the audio zoom method in FIG. 1 according to an embodiment of the present disclosure.

FIG. 3 is a schematic flowchart of step S132 in FIG. 2 according to an embodiment of the present disclosure.

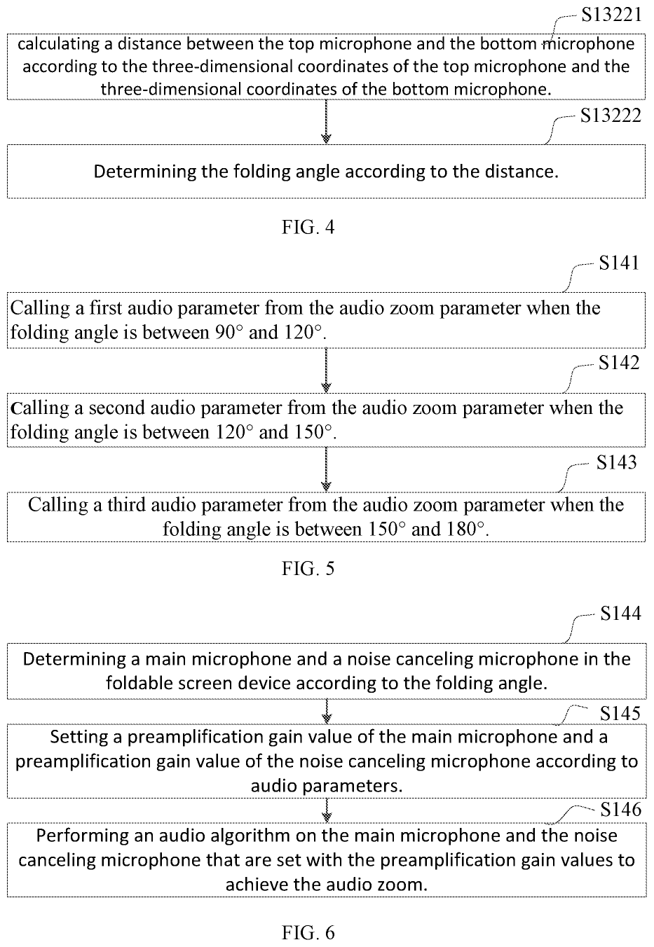

FIG. 4 is a schematic flowchart of step S1322 in FIG. 3 according to an embodiment of the present disclosure.

FIG. 5 is a schematic flowchart of step S140 of the audio zoom method in FIG. 1 according to an embodiment of the present disclosure.

FIG. 6 is another schematic flowchart of step S140 of the audio zoom method in FIG. 1 according to an embodiment of the present disclosure.

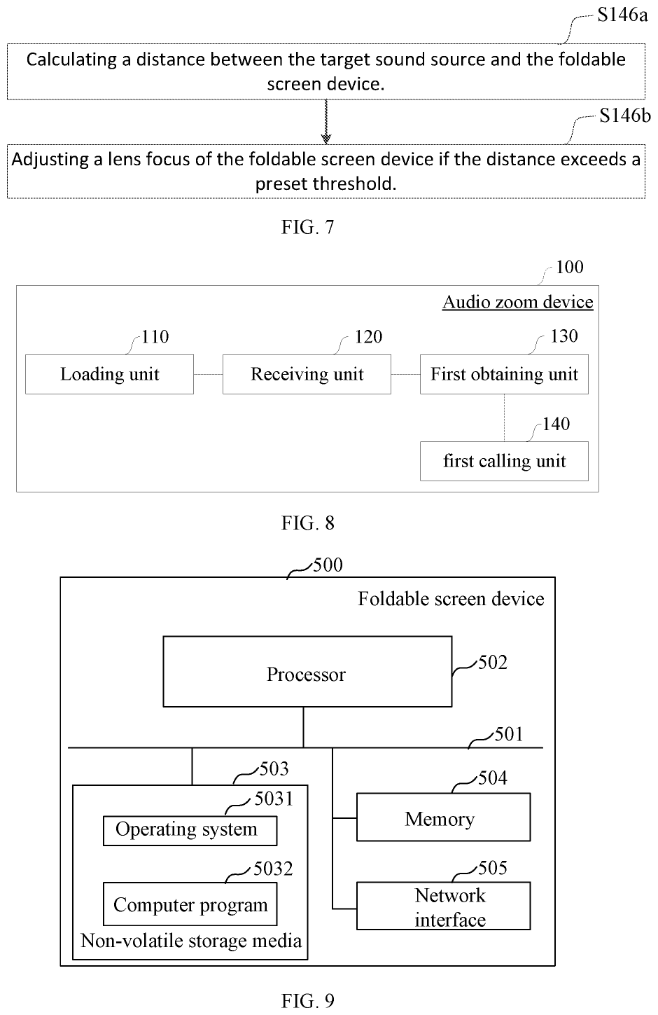

FIG. 7 is another schematic flowchart of the audio zoom method according to an embodiment of the present disclosure.

FIG. 8 is a schematic block diagram of an audio zoom device according to an embodiment of the present disclosure.

FIG. 9 is a schematic block diagram of a foldable screen device according to an embodiment of the present disclosure.

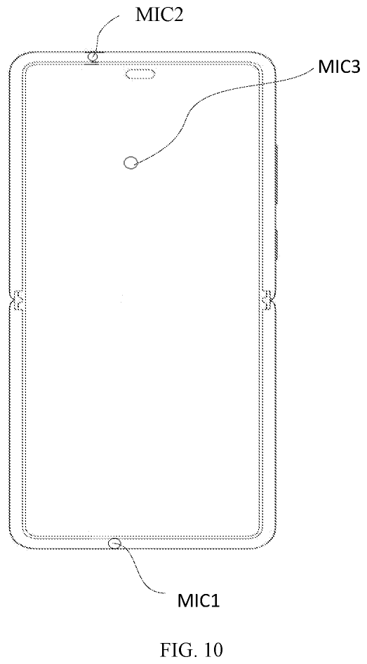

FIG. 10 is a front view of the foldable screen device folded 180° according to the embodiment of the present disclosure.

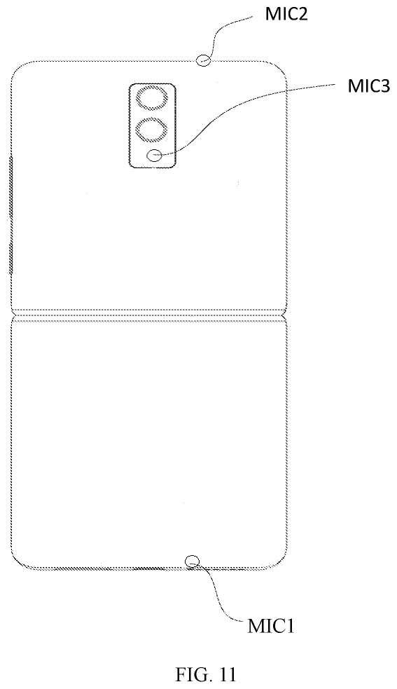

FIG. 11 is a rear view of the foldable screen device folded 180° according to the embodiment of the present disclosure.

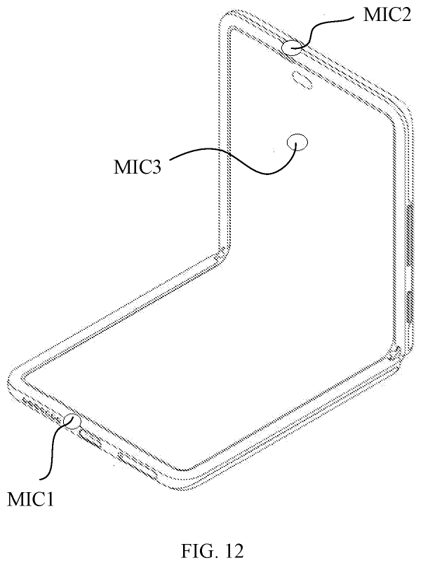

FIG. 12 is a side view of the foldable screen device folded 90° according to the embodiment of the present disclosure.

### DETAILED DESCRIPTION

The technical solutions in the embodiments of the present disclosure are clearly and completely described in conjunction with the accompanying drawings in the embodiments of the present disclosure below, and it is obvious that the described embodiments are part of the embodiments of the present disclosure, but not all embodiments. Based on the embodiments in the present disclosure, all other embodiments obtained by a person skilled in the art without creative work fall within the scope of protection of the present disclosure.

It should be understood that, when used in this specification and the accompanying claims, the terms “including” and “comprising” indicate the existence of the described features, wholes, steps, operations, elements and/or components, but do not exclude the existence or addition of one or more other features, wholes, steps, operations, elements, components and/or collections thereof.

It should also be understood that the terms used in this description of the present disclosure are only for the purpose of describing specific embodiments and are not intended to limit the present disclosure. As used in the description of the present disclosure and the accompanying claims, the singular forms “a”, “one” and “the” are intended to include the plural, unless the context clearly indicates otherwise.

It should also be further understood that the term “and/or” used in the description of this application and the accompanying claims refers to any combination and all possible combinations of one or more of the items listed in association and includes such combinations.

Please refer to FIG. 1 illustrating a flowchart of an audio zoom method according to an embodiment of the present disclosure. The audio zoom method in the present disclosure is applied to a foldable screen device, and is performed through an application software installed in the foldable screen device. The foldable screen device may be a terminal device with a function of accessing the Internet, or a terminal device without the function of accessing the Internet. The terminal device is a liquid crystal television, a desktop computer, a notebook computer, a tablet computer, a mobile phone, or the like, which has a foldable screen.

The audio zoom method is described in detail below.

As shown in FIG. 1, the method comprises the following steps S110 to S140.

S110: loading an audio zoom parameter preset in a foldable screen device.

The audio zoom parameter is parameter information preset in the foldable screen device by a supplier who manufactures the foldable screen device, so that the foldable screen device can perform audio zoom according to the audio zoom parameter. After the foldable screen device detects user's instruction information requesting video shooting, it executes the loading of the audio zoom parameter.

In this embodiment, the audio zoom parameter is set according to a folding angle of a foldable screen of the foldable screen device. The audio zoom parameter may be an audio parameter for one folding angle, or may comprise audio parameters for multiple folding angles, or may comprise audio parameters for an angle region, or may comprise audio parameters for multiple angle regions. The audio zoom parameter may be specifically set according to an actual situation, and is not specifically limited herein. S120: receiving an audio zoom request sent by a user.

Specifically, the audio zoom request is instruction information for the user to request audio zoom during video shooting with the foldable screen device, i.e., instruction information for the user to click on the foldable screen of the foldable screen device to perform audio zoom. After receiving the audio zoom request from the user, the foldable screen device performs a subsequent series of audio zoom steps and provides the user with the best audio zoom effect.

S130: obtaining a folding angle of the foldable screen device.

Specifically, the folding angle is an angle at which the foldable screen of the foldable screen device is folded when the user uses the foldable screen device to shoot videos. After obtaining the folding angle of the foldable screen device, audio zoom is performed based on an audio parameter obtained from the audio zoom parameter and matching a current folding angle of the foldable screen of the foldable screen device.

Please refer to FIG. 10 to FIG. 12. FIG. 10 is a front view of the foldable screen device folded 180° according to the embodiment of the present disclosure. FIG. 11 is a rear view of the foldable screen device folded 180° according to the embodiment of the present disclosure. FIG. 12 is a side view of the foldable screen device folded 90° according to the embodiment of the present disclosure. As shown in FIG. 10 to FIG. 12, the foldable screen device is provided with a first sound pickup microphone MIC1, a second sound pickup microphone MIC2, and a third sound pickup microphone MIC3. The first sound pickup microphone MIC1 is disposed at an uppermost end of an upper screen of the foldable screen device. The second sound pickup microphone MIC2 is disposed in a middle of an upper middle end of the upper screen of the foldable screen device. The third sound pickup microphone MIC3 is disposed at a lowermost end of a lower screen of the foldable screen device. Any sound pickup microphone may be used as a main microphone in audio zoom. Similarly, any sound pickup microphone in the foldable screen device may be used as a noise canceling microphone in audio zoom. The folding angle is an angle between the upper screen and the lower screen of the foldable screen device after folding. When the upper screen and the lower screen of the foldable screen device are parallel, the folding angle between the upper screen and the lower screen of the foldable screen device is 180°. When the upper screen and the lower screen of the foldable screen device are perpendicular to each other, the folding angle between the upper screen and the lower screen of the foldable screen device is 90°.

In another embodiment, as shown in FIG. 2, step S130 comprises steps S131 and S132.

S131: detecting a screen status of the foldable screen device through a Hall switch of the foldable screen device.

S132: calculating the folding angle according to three-dimensional coordinates of the foldable screen device when the screen state is an open state.

Specifically, the screen status is whether the foldable screen of the foldable screen device is in the open state. The three-dimensional coordinates of the foldable screen device are coordinate information of the foldable screen device in three dimensions of X, Y, and Z. A sensor in the foldable screen device obtains a current gravity parameter value of the foldable screen device, and then calculates it with a corresponding formula to obtain the three-dimensional coordinates of the foldable screen device. Finally, the folding angle is calculated based on the three-dimensional coordinates of the foldable screen device.

In this embodiment, the screen status of the foldable screen of the foldable screen device is detected through the Hall switch in the foldable screen device. The Hall switch is a switch composed of a Hall element and is disposed in the foldable screen device. A principle of the Hall switch to detect the screen status of the foldable screen device is as follows. When a magnetic element in the foldable screen device moves close to the Hall switch, the Hall element on a detection surface of the switch generates a Hall effect, which changes an internal circuit state of the switch, thereby identifying whether the foldable screen of the foldable screen device is in the open state.

In another embodiment, as shown in FIG. 3, step S132 comprises steps S1321 and S1322.

S1321: obtaining three-dimensional coordinates of a top microphone and three-dimensional coordinates of a bottom microphone in the foldable screen device.

S1322: calculating the folding angle according to the three-dimensional coordinates of the top microphone and the three-dimensional coordinates of the bottom microphone.

In this embodiment, as shown in FIG. 10 to FIG. 12, the top microphone is the second sound pickup microphone MIC2, and the bottom microphone is the first sound pickup microphone MIC1. The foldable screen device obtains its own coordinate information in the three dimensions of X, Y, and Z through its own sensor, and then calculates coordinate information of each sound pickup microphone in the three dimensions of X, Y, and Z based on parameters of the three sound pickup microphones when they are disposed in the foldable screen device, and then calculates the folding angle of the foldable screen of the foldable screen device.

In another embodiment, as shown in FIG. 4, step S1322 comprises steps S13221 and S13222.

S13221: calculating a distance between the top microphone and the bottom microphone according to the three-dimensional coordinates of the top microphone and the three-dimensional coordinates of the bottom microphone.

S13222: determine the folding angle according to the distance.

In this embodiment, a mapping table between the distance and the folding angle is preset. Therefore, after calculating the distance between the top microphone and the bottom microphone according to the three-dimensional coordinates of the top microphone and the three-dimensional coordinates of the bottom microphone, the folding angle of the foldable screen device is determined from the mapping table.

S140: calling an audio parameter that matches the folding angle from the audio zoom parameter, and performing audio zoom in the foldable screen device according to the audio parameter.

In this embodiment, the audio zoom parameter comprises multiple audio parameters. The microphone in the foldable screen device can perform audio zoom based on any audio parameter of the audio zoom parameter. Each folding angle of the foldable screen device corresponds to one audio parameter of the audio zoom parameters. Therefore, after obtaining the folding angle of the foldable screen device, the audio parameter corresponding to the folding angle of the foldable screen device is called from the loaded audio zoom parameter. The sound pickup microphone in the foldable screen device performs an audio algorithm in the foldable screen device according to the called audio parameter, thereby achieving audio zoom.

In another embodiment, as shown in FIG. 5, step S140 comprises steps S141, S142, and S143.

S141: calling a first audio parameter from the audio zoom parameter when the folding angle is between 90° and 120°.

S142: calling a second audio parameter from the audio zoom parameter when the folding angle is between 120° and 150°.

S143: calling a third audio parameter from the audio zoom parameter when the folding angle is between 150° and 180°.

In this embodiment, the audio zoom parameter comprises the first audio parameter, the second audio parameter, and the third audio parameter. The first audio parameter is parameter information used by the sound pickup microphone to perform the audio algorithm when the folding angle of the foldable screen device is between 90° and 120°. The second audio parameter is parameter information used by the sound pickup microphone to perform the audio algorithm when the folding angle of the foldable screen device is between 120° and 150°. The third audio parameter is parameter information used by the sound pickup microphone to perform the audio algorithm when the folding angle of the foldable screen device is between 150° and 180°. A difference among the first audio parameter, the second audio parameter, and the third audio parameter is that parameter information used to set preamplification gain values of the microphones and define primary and secondary roles of the microphones. In addition, when the folding angle of the foldable screen device is less than 90° or the foldable screen of the foldable screen device is in a closed state, the foldable screen device cannot adjust a lens focus to obtain a target object for audio zoom. At this time, the foldable screen device cannot call an audio parameter from the audio zoom parameter to perform audio zoom, and returns to a state of loading the preset audio zoom parameter.

In another embodiment, as shown in FIG. 6, step S140 further comprises steps S144, S145, and S146.

S144: determining a main microphone and a noise canceling microphone in the foldable screen device according to the folding angle.

S145: setting a preamplification gain value of the main microphone and a preamplification gain value of the noise canceling microphone according to audio parameters.

S146: performing an audio algorithm on the main microphone and the noise canceling microphone that are set with the preamplification gain values to achieve the audio zoom.

In this embodiment, a mapping table between the folding angle and position information of the main microphone and the noise canceling microphone in the foldable screen device is preset. After obtaining the folding angle of the foldable screen device, current position information of the main microphone and the noise cancelling microphone is obtained from the mapping table, and then the main microphone and the noise cancelling microphone are determined in the foldable screen device. After determining the main microphone and the noise canceling microphone, the preamplification gain values of the main microphone and the noise canceling microphone in the foldable screen device are set according to the called zoom parameters, and then the audio algorithm is performed to achieve the audio zoom in the foldable screen device.

For example, as shown in FIG. 12, when the folding angle is between 90° and 120°, the foldable device is in a desktop placement mode. At this time, the third sound pickup microphone MIC3 on a back of the foldable device is closest to a target sound source, so the third sound pickup microphone MIC3 serves as the main microphone, and the first sound pickup microphone MIC1 and the second sound pickup microphone MIC2 serve as slave microphones. A preamplification gain value of the third sound pickup microphone MIC3 is greater than preamplification gain values of the first sound pickup microphone MIC1 and the second sound pickup microphone MIC2, so as to ensure that the recorded target sound is the loudest. The first sound pickup microphone MIC1 and the second sound pickup microphone MIC2 serve as the noise canceling microphones to suppress sound sources outside a target range.

A core idea of the audio algorithm is as follows. When the device is in a video shooting mode, when a video shooting screen is focused to a specific position to record an audio of a target at that position, a target sound will become louder as a focal length of a video increases, and interfering sound sources from other directions will be suppressed. If the target sound source is far away from the device and is not clear, adjust a lens focus to zoom in, and the target sound source will be zoomed in to the device accordingly. If the target sound source is interfered by noisy surrounding sound sources, just zoom in on the screen, and the target sound source will be zoomed in to the device accordingly.

In another embodiment, as shown in FIG. 7, before step S146, the method further comprises steps S146a and S146b.

S146a: calculating a distance between the target sound source and the foldable screen device.

S146b: adjusting a lens focus of the foldable screen device if the distance exceeds a preset threshold.

In this embodiment, the foldable screen device calculates the distance between the target sound source and the foldable screen device by detecting an intensity of the current target sound source transmitted to the foldable screen device, and then determines whether the distance exceeds the preset threshold. If the distance exceeds the preset threshold, the foldable screen device automatically adjusts the lens focus, so that the main microphone can better record the target sound source.

In the present disclosure, parameters for audio zoom are pre-loaded in a foldable screen device. When the user requests audio zoom, the foldable screen device directly obtains a folding angle of the foldable screen device, and then obtains one parameter that matches the folding angle from the loaded parameters based on the folding angle, thereby realizing automatic audio zoom on a foldable screen. This solves solve a technical problem in the existing technology that an audio zoom effect is poor when a foldable screen phone is folded at multiple angles, allowing users to experience the best audio zoom effect during video shooting no matter how they fold the foldable screen.

The present disclosure further provides an audio zoom device 100 for executing the audio zoom method in any of the above embodiments.

Specifically, please refer to FIG. 8, which is a block diagram of the audio zoom device 100 according to an embodiment of the present disclosure.

As shown in FIG. 8, the audio zoom device 100 comprises a loading unit 110, a receiving unit 120, a first obtaining unit 130, and a first calling unit 140.

The loading unit 110 is configured to load an audio zoom parameter preset in a foldable screen device.

The receiving unit 120 is configured to receive an audio zoom request sent by a user.

The first obtaining unit 130 is configured to obtain a folding angle of the foldable screen device.

In another embodiment, the first obtaining unit 130 comprises a detection unit and a first calculation unit.

The detection unit is configured to detect a screen status of the foldable screen device through a Hall switch of the foldable screen device. The first calculation unit is configured to calculate the folding angle according to three-dimensional coordinates of the foldable screen device if the screen status is an open state.

In another embodiment, the first calculation unit comprises a second obtaining unit and a second calculation unit.

The second obtaining unit is configured to obtain three-dimensional coordinates of a top microphone and three-dimensional coordinates of a bottom microphone in the foldable screen device. The second calculation unit is configured to calculate the folding angle according to the three-dimensional coordinates of the top microphone and the three-dimensional coordinates of the bottom microphone.

In another embodiment, the second calculation unit comprises a third calculation unit and a first determination unit.

The third calculation unit is configured to calculate a distance between the top microphone and the bottom microphone according to the three-dimensional coordinates of the top microphone and the three-dimensional coordinates of the bottom microphone. The first determination unit is configured to determine the folding angle according to the distance.

The first calling unit 140 is configured to call an audio parameter that matches the folding angle from the audio zoom parameter, and perform audio zoom in the foldable screen device according to the audio parameter.

In another embodiment, the first calling unit 140 comprises a second calling unit, a third calling unit, and a fourth calling unit.

The second calling unit is configured to call a first audio parameter from the audio zoom parameter if the folding angle is between 90° and 120°. The third calling unit is configured to call a second audio parameter from the audio zoom parameter if the folding angle is between 120° and 150°. The fourth calling unit is configured to call a third audio parameter from the audio zoom parameter if the folding angle is between 150° and 180°.

In another embodiment, the first calling unit 140 further comprises a second determining unit, a setting unit, and an audio algorithm unit.

The second determination unit is configured to determine a main microphone and a noise canceling microphone in the foldable screen device according to the folding angle. The setting unit is configured to set a preamplification gain value of the main microphone and a preamplification gain value of the noise canceling microphone according to the audio parameter. The audio algorithm unit is configured to perform an audio algorithm on the main microphone and the noise canceling microphone that are set with the preamplification gain values to achieve the audio zoom.

In another embodiment, the audio zoom device 100 further comprises: a fourth calculation unit and an adjustment unit.

The fourth calculation unit is configured to calculate a distance between a target sound source and the foldable screen device. The adjustment unit is configured to adjust a lens focus of the foldable screen device if the distance exceeds a preset threshold.

The audio zoom device 100 provided by the present disclosure is configured to load an audio zoom parameter preset in a foldable screen device, receive an audio zoom request sent by a user, obtain a folding angle of the foldable screen device, call an audio parameter that matches the folding angle from the audio zoom parameter, and perform audio zoom in the foldable screen device according to the audio parameter.

It should be noted that those skilled in the art can clearly understand that for specific implementation of the audio zoom device 100 and each unit thereof, reference may be made to the corresponding descriptions in the foregoing method embodiments, and for convenience and simplicity of description, it will not be described in detail herein.

The audio zoom device may be implemented as a computer program. The computer program may run on a foldable screen device 500 as shown in FIG. 9.

Please refer to FIG. 9, which a block diagram of the foldable screen device 500 according to an embodiment of the present disclosure. The foldable screen device 500 may be a terminal. The terminal may be an electronic device with a foldable screen and a communication function such as a smartphone, a tablet computer, a notebook computer, a desktop computer, a personal digital assistant, and a wearable device.

Please refer to FIG. 9, the foldable screen device 500 comprises a processor 502, a memory, and a network interface 505 that are connected through a system bus 501. The memory may comprise a non-volatile storage media 503 and a memory 504.

The non-volatile storage medium 503 may store an operating system 5031 and computer program 5032. The computer program 5032 comprises program instructions that, when executed, causes the processor 502 to perform the audio zoom method.

The processor 502 is used to provide computing and control capability to support the operation of the entire foldable screen device 500.

The memory 504 provides an environment for the operation of computer program 5032 in a non-volatile storage medium 503, which, when executed by the processor 5032, causes the processor 502 to perform an audio zoom method.

The network interface 505 is used for network communication with other devices. Those skilled in the art can understand that the structure shown in FIG. 9 is only a block diagram of a part of the structure related to the present disclosure, and does not constitute a limitation of the foldable screen device 500 applied to the present disclosure. The specific foldable screen device 500 may include more or fewer parts than those shown, or combine certain parts, or have different parts arranged.

The processor 502 is used for running computer program 5032 stored in the memory 504 to realize the following operations: loading an audio zoom parameter preset in the foldable screen device; receiving an audio zoom request sent by a user; obtaining a folding angle of the foldable screen device; and in response to the audio zoom request, calling an audio parameter that matches the folding angle from the audio zoom parameter, and performing audio zoom in the foldable screen device according to the audio parameter.

In one embodiment of the present disclosure, upon obtaining the folding angle of the foldable screen device, the processor 502 performs the following operations: detecting a screen status of the foldable screen device through a Hall switch of the foldable screen device; and calculating the folding angle according to three-dimensional coordinates of the foldable screen device if the screen state is an open state.

In one embodiment of the present disclosure, upon calculating the folding angle according to the three-dimensional coordinates of the foldable screen device, the processor 502 performs the following operations: obtaining three-dimensional coordinates of a top microphone and three-dimensional coordinates of a bottom microphone in the foldable screen device; and calculating the folding angle according to the three-dimensional coordinates of the top microphone and the three-dimensional coordinates of the bottom microphone.

In one embodiment of the present disclosure, upon calculating the folding angle according to the three-dimensional coordinates of the top microphone and the three-dimensional coordinates of the bottom microphone, the processor 502 performs the following operations: calculating a distance between the top microphone and the bottom microphone according to the three-dimensional coordinates of the top microphone and the three-dimensional coordinates of the bottom microphone; and determining the folding angle according to the distance.

In one embodiment of the present disclosure, upon calling the audio parameter that matches the folding angle from the audio zoom parameter, the processor 502 performs the following operations: calling a first audio parameter from the audio zoom parameter if the folding angle is between 90° and 120°; calling a second audio parameter from the audio zoom parameter if the folding angle is between 120° and 150°; and calling a third audio parameter from the audio zoom parameter if the folding angle is between 150° and 180°.

In one embodiment of the present disclosure, upon performing the audio zoom in the foldable screen device according to the audio parameter, the processor 502 performs the following operations: determining a main microphone and a noise canceling microphone in the foldable screen device according to the folding angle; setting a preamplification gain value of the main microphone and a preamplification gain value of the noise canceling microphone according to audio parameters; and performing an audio algorithm on the main microphone and the noise canceling microphone that are set with the preamplification gain values to achieve the audio zoom.

In one embodiment of the present disclosure, before performing the audio algorithm on the main microphone and the noise canceling microphone that are set with the preamplification gain values to achieve the audio zoom, the processor 502 performs the following operations: calculating a distance between the target sound source and the foldable screen device; and adjusting a lens focus of the foldable screen device if the distance exceeds a preset threshold.

It should be understood that in the embodiment of the present disclosure, the processor 502 may be a Central Processing Unit (CPU), or other general-purpose processors, Digital Signal Processors (DSPs), Application-Specific Integrated Circuits (ASICs), Field-Programmable Gate Arrays (FPGAs) or other programmable logic devices, discrete gates or transistor logic devices, discrete hardware components and so on. The general-purpose processor can be a microprocessor, or the processor can also be any conventional processor.

A person skilled in the art can understand that all or part of the process in the method for realizing the above embodiments can be completed by instructing the relevant hardware through a computer program. The computer program comprises program instructions. The computer program can be stored in a storage medium, which is a computer-readable storage medium. The program instructions are executed by at least one processor in the computer system to implement the steps of the embodiment of the above method.

Accordingly, the present disclosure also provides a computer-readable storage medium that stores computer programs, where the computer programs include program instructions. When the program instructions are executed by the processor, the processor performs the following operations: loading an audio zoom parameter preset in the foldable screen device; receiving an audio zoom request sent by a user; obtaining a folding angle of the foldable screen device; and in response to the audio zoom request, calling an audio parameter that matches the folding angle from the audio zoom parameter, and performing audio zoom in the foldable screen device according to the audio parameter.

In one embodiment of the present disclosure, upon obtaining the folding angle of the foldable screen device, the processor executes program instructions to perform the following operations: detecting a screen status of the foldable screen device through a Hall switch of the foldable screen device; and calculating the folding angle according to three-dimensional coordinates of the foldable screen device if the screen state is an open state.

In one embodiment of the present disclosure, upon calculating the folding angle according to the three-dimensional coordinates of the foldable screen device, the processor executes program instructions to perform the following operations: obtaining three-dimensional coordinates of a top microphone and three-dimensional coordinates of a bottom microphone in the foldable screen device; and calculating the folding angle according to the three-dimensional coordinates of the top microphone and the three-dimensional coordinates of the bottom microphone.

In one embodiment of the present disclosure, upon calculating the folding angle according to the three-dimensional coordinates of the top microphone and the three-dimensional coordinates of the bottom microphone, the processor executes program instructions to perform the following operations: calculating a distance between the top microphone and the bottom microphone according to the three-dimensional coordinates of the top microphone and the three-dimensional coordinates of the bottom microphone; and determining the folding angle according to the distance.

In one embodiment of the present disclosure, upon calling the audio parameter that matches the folding angle from the audio zoom parameter, the processor executes program instructions to perform the following operations: calling a first audio parameter from the audio zoom parameter if the folding angle is between 90° and 120°; calling a second audio parameter from the audio zoom parameter if the folding angle is between 120° and 150°; and calling a third audio parameter from the audio zoom parameter if the folding angle is between 150° and 180°.

In one embodiment of the present disclosure, upon performing the audio zoom in the foldable screen device according to the audio parameter, the processor executes program instructions to perform the following operations: determining a main microphone and a noise canceling microphone in the foldable screen device according to the folding angle; setting a preamplification gain value of the main microphone and a preamplification gain value of the noise canceling microphone according to audio parameters; and performing an audio algorithm on the main microphone and the noise canceling microphone that are set with the preamplification gain values to achieve the audio zoom.

In one embodiment of the present disclosure, before performing the audio algorithm on the main microphone and the noise canceling microphone that are set with the preamplification gain values to achieve the audio zoom, the processor executes program instructions to perform the following operations: calculating a distance between the target sound source and the foldable screen device; and adjusting a lens focus of the foldable screen device if the distance exceeds a preset threshold.

The storage medium may be a U disk, a mobile hard disk, a read-only memory (Read-Only Memory, ROM), a magnetic disk or an optical disc and other computer-readable storage media that can store program code.

Those skilled in the art may realize that the units and algorithm steps of each example described in conjunction with the embodiments disclosed herein can be realized by electronic hardware, computer software, or a combination of both, and in order to clearly illustrate the interchangeability of hardware and software, the composition and steps of each example have been described in general according to their functions in the above description. Whether these functions are performed in hardware or software depends on the specific application and design constraints of the technical solution. A skilled person may use different methods to achieve the described function for each particular application, but such implementation shall not be considered outside the scope of the present disclosure.

In some embodiments provided in the present disclosure, it should be understood that the device and method disclosed can be realized by other means. For example, the device embodiments described above are only schematic. For example, the division of each unit is only a logical function, and there can be another division in the actual implementation. For example, multiple units or components can be combined or integrated into another system, or some features can be ignored or not executed.

The steps in the embodiment method of the present disclosure may be adjusted, merged and reduced sequentially according to actual needs. The units in the embodiment of the present disclosure can be merged, divided and deleted according to actual needs. In addition, each functional unit in each embodiment of the present disclosure may be integrated in a processing unit, or each unit may physically exist separately, or two or more units may be integrated in a single unit.

The integrated unit can be stored in a storage medium if it is implemented as a software function unit and when sold or used as a stand-alone product. Based on this understanding, the technical solution of the present disclosure is essentially or the part that contributes to the prior art, or the whole or part of the technical solution can be embodied in the form of a software product, and the computer software product is stored in a storage medium and includes a plurality of instructions for enabling a folding screen device (which may be a personal computer, a terminal, or a network device, etc.) to perform all or part of the steps of the method described in each embodiment of the present disclosure.

The above are specific embodiments of the present disclosure, but the claimed scope of the present disclosure is not limited thereto. Those skilled in the art can easily think of various equivalent modifications or replacements within the technical scope disclosed in the present disclosure. These modifications or replacements should be covered by the claimed scope of the present disclosure. Therefore, the claimed scope of the present disclosure should be determined by claims.

1. A audio zoom method applied in a foldable screen device, comprising:
loading an audio zoom parameter preset in the foldable screen device;
receiving an audio zoom request sent by a user;
obtaining a folding angle of the foldable screen device; and
in response to the audio zoom request, calling an audio parameter that matches the folding angle from the audio zoom parameter, and performing audio zoom in the foldable screen device according to the audio parameter.

2. The method according to claim 1, wherein the obtaining the folding angle of the foldable screen device comprises:
detecting a screen status of the foldable screen device through a Hall switch of the foldable screen device; and
calculating the folding angle according to three-dimensional coordinates of the foldable screen device when the screen state is an open state.

3. The method according to claim 2, wherein the calculating the folding angle according to the three-dimensional coordinates of the foldable screen device:
obtaining three-dimensional coordinates of a top microphone and three-dimensional coordinates of a bottom microphone in the foldable screen device; and
calculating the folding angle according to the three-dimensional coordinates of the top microphone and the three-dimensional coordinates of the bottom microphone.

4. The method according to claim 3, wherein calculating the folding angle according to the three-dimensional coordinates of the top microphone and the three-dimensional coordinates of the bottom microphone comprises:
calculating a distance between the top microphone and the bottom microphone according to the three-dimensional coordinates of the top microphone and the three-dimensional coordinates of the bottom microphone; and
determining the folding angle according to the distance.

5. The method according to claim 4, wherein the determining the folding angle according to the distance comprises:
obtaining a preset mapping table between the distance and the folding angle; and
determining the folding angle from the preset mapping table according to the distance.

6. The method according to claim 1, wherein the calling the audio parameter that matches the folding angle from the audio zoom parameter comprises:
calling a first audio parameter from the audio zoom parameter when the folding angle is between 90° and 120°;
calling a second audio parameter from the audio zoom parameter when the folding angle is between 120° and 150°; and
calling a third audio parameter from the audio zoom parameter when the folding angle is between 150° and 180°.

7. The method according to claim 1, wherein the performing the audio zoom in the foldable screen device according to the audio parameter comprises:
determining a main microphone and a noise canceling microphone in the foldable screen device according to the folding angle;
setting a preamplification gain value of the main microphone and a preamplification gain value of the noise canceling microphone according to audio parameters; and
performing an audio algorithm on the main microphone and the noise canceling microphone that are set with the preamplification gain values to achieve the audio zoom.

8. The method according to claim 7, before the performing the audio algorithm on the main microphone and the noise canceling microphone that are set with the preamplification gain values to achieve the audio zoom, further comprising:
calculating a distance between the target sound source and the foldable screen device; and
adjusting a lens focus of the foldable screen device when the distance exceeds a preset threshold.

9. The method according to claim 8, wherein the calculating a distance between the target sound source and the foldable screen device comprises:
detecting an intensity of the target sound source transmitted to the folding screen device; and
calculating the distance between the target sound source and the folding screen device according to the intensity.

10. The method according to claim 1, wherein the audio zoom parameter includes s plurality of audio parameters, and the performing the audio zoom in the foldable screen device according to the audio parameter comprises:
performing the audio zoom in the foldable screen device according to any one of the audio parameters.

11. The method according to claim 1, wherein the audio zoom request is instruction information requesting audio zoom during video shooting using the foldable screen device.

12-18. (canceled)

19. A foldable screen device, comprising a memory, a processor, and a computer program stored in the memory and executable by the processor, wherein the processor executes the computer program to perform operations comprising:
loading an audio zoom parameter preset in the foldable screen device;
receiving an audio zoom request sent by a user;
obtaining a folding angle of the foldable screen device; and
in response to the audio zoom request, calling an audio parameter that matches the folding angle from the audio zoom parameter, and performing audio zoom in the foldable screen device according to the audio parameter.

20. (canceled)

21. The foldable screen device according to claim 19, wherein the obtaining the folding angle of the foldable screen device comprises:
detecting a screen status of the foldable screen device through a Hall switch of the foldable screen device; and
calculating the folding angle according to three-dimensional coordinates of the foldable screen device when the screen state is an open state.

22. The foldable screen device according to claim 21, wherein the calculating the folding angle according to the three-dimensional coordinates of the foldable screen device:
obtaining three-dimensional coordinates of a top microphone and three-dimensional coordinates of a bottom microphone in the foldable screen device; and
calculating the folding angle according to the three-dimensional coordinates of the top microphone and the three-dimensional coordinates of the bottom microphone.

23. The foldable screen device according to claim 22, wherein calculating the folding angle according to the three-dimensional coordinates of the top microphone and the three-dimensional coordinates of the bottom microphone comprises:
calculating a distance between the top microphone and the bottom microphone according to the three-dimensional coordinates of the top microphone and the three-dimensional coordinates of the bottom microphone; and
determining the folding angle according to the distance.

24. The foldable screen device according to claim 23, wherein the determining the folding angle according to the distance comprises:
obtaining a preset mapping table between the distance and the folding angle; and
determining the folding angle from the preset mapping table according to the distance.

25. The foldable screen device according to claim 19, wherein the calling the audio parameter that matches the folding angle from the audio zoom parameter comprises:
calling a first audio parameter from the audio zoom parameter when the folding angle is between 90° and 120°;
calling a second audio parameter from the audio zoom parameter when the folding angle is between 120° and 150°; and
calling a third audio parameter from the audio zoom parameter when the folding angle is between 150° and 180°.

26. The foldable screen device according to claim 19, wherein the performing the audio zoom in the foldable screen device according to the audio parameter comprises:
determining a main microphone and a noise canceling microphone in the foldable screen device according to the folding angle;
setting a preamplification gain value of the main microphone and a preamplification gain value of the noise canceling microphone according to audio parameters; and
performing an audio algorithm on the main microphone and the noise canceling microphone that are set with the preamplification gain values to achieve the audio zoom.

27. The foldable screen device according to claim 26, before the performing the audio algorithm on the main microphone and the noise canceling microphone that are set with the preamplification gain values to achieve the audio zoom, further comprising:
calculating a distance between the target sound source and the foldable screen device; and
adjusting a lens focus of the foldable screen device when the distance exceeds a preset threshold.

28. The foldable screen device according to claim 27, wherein the calculating a distance between the target sound source and the foldable screen device comprises:
detecting an intensity of the target sound source transmitted to the folding screen device; and
calculating the distance between the target sound source and the folding screen device according to the intensity.

29. The foldable screen device according to claim 19, wherein the audio zoom parameter includes a plurality of audio parameters, and the performing the audio zoom in the foldable screen device according to the audio parameter comprises:
performing the audio zoom in the foldable screen device according to any one of the audio parameters.
